(19) United States
(12) Patent Application Publication
(10) Pub. No.: US 2011/0255579 A1
(43) Pub. Date: Oct. 20, 2011

(54) COMMUNICATION APPARATUS, METHOD OF CONTROLLING SAME AND COMMUNICATION SYSTEM

(75) Inventor: Tadashi Eguchi, Tokyo (JP)

(73) Assignee: CANON KABUSHIKI KAISHA, Tokyo (JP)

(21) Appl. No.: 13/141,390

(22) PCT Filed: Mar. 2, 2010
(86) PCT No.: PCT/JP2010/053712

§ 371 Date: Jun. 22, 2011

(30) Foreign Application Priority Data
Mar. 16, 2009 (JP) 2009-063235

(51) Int. Cl. H04B 1/38; H04L 27/28

(52) U.S. Cl. 375/219; 375/260

(57) ABSTRACT

In order to achieve more efficient data transfer by broadcast, a communication apparatus receives data that has been broadcast from a transmitting apparatus to a plurality of communication apparatuses, and transmits a response signal regarding the data using a carrier different from those of the other communication apparatuses from among a plurality of mutually orthogonal carriers.

### TECHNICAL FIELD

The present invention relates to technology for transmitting data by broadcast.

### BACKGROUND ART

It is known that when data is transmitted from a transmitting station to a plurality of receiving stations, it is effective to employ broadcast communication, which transmits data to a plurality of receiving stations at one time by means of a single packet. When broadcast communication is performed, there are instances where a response signal to notify the state of data reception is sent to the transmitting station from each receiving station. Response signals include an acknowledgement (Ack) signal transmitted if data has been received normally, and a negative acknowledgement (Nack) signal transmitted if data could not be received. In cases where a response signal is used in broadcast communication, however, there is the possibility that communication will be inefficient, depending upon the method of response-signal utilization.

Accordingly, US publication no. 2006/0291410 discloses technology in which a receiving station refrains from issuing a reception response if a Nack signal has been detected from another receiving station, and only a representative receiving station transmits an Ack signal, thereby improving the efficiency of the reception response.

In this example of the prior art, however, a problem that arises is that if a repeater station or transmitting station fails to receive a Nack signal regarding certain data, then the transmitting station cannot re-send this data. A further problem is that in an arrangement in which only a representative station transmits an Ack signal, it is required that the representative station detect the Ack signals of other terminals, there is a great degree of redundancy of reception responses and the system is inefficient. Yet another problem is that in communication that relies upon frequency division, as in an FDMA (Frequency Division Multiple Access) system, the frequency band narrows and, as a consequence, the system is vulnerable to multipath fading.

### DISCLOSURE OF INVENTION

The present invention provides solutions for the above-mentioned problems and improves the efficiency of data transfer by broadcast.

According to one aspect of the present invention, a communication apparatus comprises: receiving means for receiving data that has been broadcast from a transmitting apparatus to a plurality of communication apparatuses; and transmitting means for transmitting a response signal regarding the data received by the receiving means, using a carrier different from carriers of the other communication apparatuses from among a plurality of mutually orthogonal carriers.

According to another aspect of the present invention, a communication apparatus comprises: transmitting means for broadcasting data to a plurality of communication parties; and receiving means for receiving response signals, which indicate states of reception of the data, from the plurality of communication parties; wherein the receiving means receives the response signals transmitted using carriers, which are different for every communication party, from among a plurality of mutually orthogonal carriers.

According to still another aspect of the present invention, a method of controlling a communication apparatus, comprises: a receiving step of receiving data that has been broadcast from a transmitting apparatus to a plurality of communication apparatuses; and a transmitting step of transmitting a response signal regarding the data using a carrier different from carriers of the other communication apparatuses from among a plurality of mutually orthogonal carriers.

According to yet another aspect of the present invention, a method of controlling a communication apparatus, comprises: a broadcasting step of broadcasting data to a plurality of communication parties using a plurality of carriers; and a receiving step of receiving response signals, which indicate states of reception of the data, from the plurality of communication parties; wherein the response signals transmitted using carriers, which are different for every communication party, from among a plurality of mutually orthogonal carriers are received at the receiving step.

According to still yet another aspect of the present invention, a communication system comprises a transmitting apparatus and a receiving apparatus, wherein the transmitting apparatus includes first transmitting means for broadcasting data to a plurality of receiving apparatuses; and the receiving apparatus includes: receiving means for receiving the data transmitted by the first transmitting means; and second transmitting means for transmitting a response signal regarding the data received by the receiving means, using a carrier different from carriers of the other communication apparatuses from among a plurality of mutually orthogonal carriers.

In accordance with the present invention, data transfer by broadcast can be achieved more efficiently.

Further features of the present invention will become apparent from the following description of exemplary embodiments (with reference to the attached drawings).

### BRIEF DESCRIPTION OF DRAWINGS

FIG. 1 is a diagram illustrating arrangement of radio stations that construct a wireless communication system according to a first embodiment of the present invention;

FIG. 2 is a diagram illustrating an example of the configuration of a transmitter and a receiver with which a radio station is equipped;

FIGS. 3A and 3B are diagrams schematically illustrating the relationship among the frequencies of response signals from respective radio stations;

FIG. 4 is a diagram illustrating an example of the configuration of a transmitter and a receiver with which a radio station is equipped according to a second embodiment of the present invention;

FIG. 5 is a diagram illustrating the internal configuration of a demodulator according to a third embodiment of the present invention;

FIGS. 6A and 6B are diagrams exemplifying outputs from combiners when the demodulator shown in FIG. 5 is used; and

FIG. 7 is a diagram illustrating the internal configuration of a demodulator according to a fourth embodiment of the present invention.

### BEST MODE FOR CARRYING OUT THE INVENTION

A first embodiment of a wireless communication system according to the present invention will be described taking as an example a wireless communication system that utilizes OFDM (Orthogonal Frequency Division Multiplexing) employing multiple subcarriers. To simplify the description, a configuration will be described in which a radio station 101 transmits data and radio stations 102 to 106 receive the data. However, an arrangement in which each radio station is capable of both sending and receiving data is also permissible.

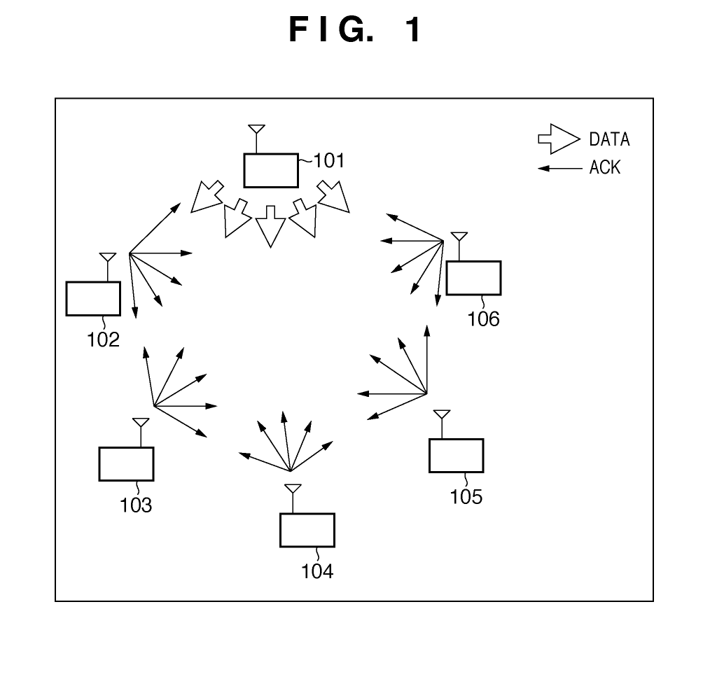

FIG. 1 is a diagram illustrating arrangement of radio stations that construct a wireless communication system according to the first embodiment.

The radio station (transmitting station) 101 broadcasts data utilizing OFDM technology, and the radio stations (receiving stations) 102 to 106 receive the data that has been broadcast from the radio station 101. Further, each of the radio stations 102 to 106 serving as receiving stations is adapted so as to transmit an Ack signal based upon the data reception state of the data transmitted from the radio station 101. It should be noted that each of the radio stations 102 to 106 is adapted so as to be capable also of receiving Ack signals transmitted from the other radio stations.

<Internal configuration of radio stations>

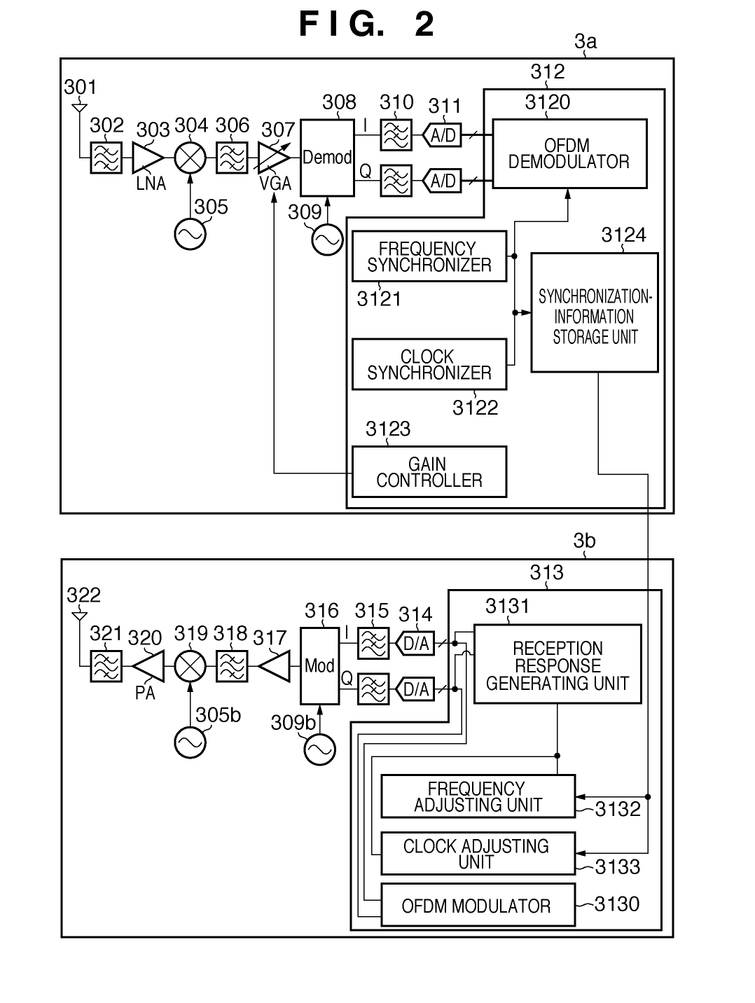

FIG. 2 is a diagram illustrating an example of the configuration of a transmitter and a receiver with which a radio station is equipped. Although the structure of the transmitter and receiver provided in each of the radio stations 102 to 106 serving as receiving stations is described below, a similar structure can also be adopted for the transmitter and receiver of the radio station 101.

The functions of each of the radio stations 102 to 106 will be described in line with a signal flow from receipt of an OFDM signal, which has been broadcast from the radio station 101, by a receiver 3a, to transmission of an Ack by a transmitter 3b.

The receiver 3a of the radio station has a receiving antenna 301 for capturing incoming radio waves as an electric signal within the receiver. The electric signal thus input from the receiving antenna 301 is input to a low-noise amplifier 303, which is for amplifying the electric signal, via an RF (Radio Frequency) band-pass filter 302 for extracting only a prescribed RF band. The signal is thenceforth frequency-converted from the RF band to the IF (Intermediate Frequency) band by a down-converter 304. A first local frequency oscillator 305 is utilized by the down-converter 304.

The signal thus down-converted to the IF band is input via an IF band-pass filter 306 to a variable gain amplifier 307 for automatic gain control. The automatic gain control performed by the variable gain amplifier 307 will be described later.

The output signal from the variable gain amplifier 307 is then separated by a demodulator IC 308 into an in-phase (I) component and quadrature-phase (Q) component of a baseband signal. A second local frequency oscillator 309 is utilized by the demodulator IC 308. The I-component and Q-component signals are input via respective baseband low-pass filters 310 and AD converters 311 to a demodulated-signal processing unit 312 constructed in the form of a digital IC.

An OFDM demodulator 3120 within the demodulated-signal processing unit 312 demodulates the data based upon the I- and Q-component signal that have been input thereto. A frequency synchronizer 3121 is a functional unit which, when the OFDM demodulator 3120 receives the signal, performs frequency synchronization by synchronizing the local frequency to this signal or by applying a correcting operation. Similarly, a clock synchronizer 3122 is a functional unit for performing clock synchronization by synchronizing a reference clock (not shown) to the received signal or by applying a correction thereto. The demodulated-signal processing unit 312 includes also a gain controller 3123 for controlling the gain of variable gain amplifier 307, and a synchronization-information storage unit 3124 for storing synchronization information (frequency-synchronization information and clock-synchronization information) indicative of the state of synchronization in the demodulated-signal processing unit 312.

In an ordinary OFDM radio station that performs packet communication, a receiving station performs frequency synchronization and clock synchronization utilizing a preamble and pilot contained in the OFDM signal transmitted from the transmitting station. In the first embodiment, for example, the radio stations 102 to 106 serving as the receiving stations each synchronize the frequency and clock based upon the preamble and pilot contained in the OFDM signal that has been broadcast from the radio station 101, and demodulate the data contained in this OFDM signal.

It should be noted that FIG. 2 is drawn in such a manner that the frequency synchronizer 3121 performs an adjustment within the demodulated-signal processing unit 312. However, frequency synchronization can just as well be performed by adjusting the frequency of the local frequency oscillator 305 or 309. Further, although the drawing is such that the clock synchronizer 3122 also performs adjustment within the demodulated-signal processing unit 312, clock synchronization can just as well be performed by adjusting a clock generator, which is not shown.

The transmitter 3b of the radio station has a modulation-signal generating unit 313 within which a frequency adjusting unit 3132 and a clock adjusting unit 3133 are functional units which, based upon the synchronization information stored in the synchronization-information storage unit 3124, perform frequency synchronization and clock synchronization with respect to the OFDM signal received by the receiver 3a. A reception response generating unit 3131 generates a response signal (Ack) using the frequency and clock adjusted by the frequency adjusting unit 3132 and clock adjusting unit 3133.

Further, and OFDM modulator 3130 for transmitting data by an OFDM signal can also be included in the modulation signal generating unit 313. In this case, it is possible for the modulation signal generating unit 313 to output both the Ack signal, which is transmitted if this station is a receiving station, and the OFDM signal, which is transmitted when this station is a transmitting station. In other words, in the case of this arrangement, this radio station is capable of performing the roles of a broadcast-communication transmitting station, repeater station and receiving station.

It should be noted that FIG. 2 is drawn in such a manner that the frequency adjusting unit 3132 performs an adjustment within the modulation signal generating unit 313. However, the frequency of a local frequency oscillator 305a or 309b can just as well be adjusted. Further, the local frequency oscillator 305a and local frequency oscillator 309b may be one and the same with the local frequency oscillator 305 and local frequency oscillator 309. Further, although the drawing is such that the clock adjusting unit 3133 also performs adjustment within the modulation signal generating unit 313, a clock generator (not shown) can just as well be adjusted.

Signals output as I- and Q-component signals from the reception response generating unit 3131 or OFDM modulator 3130 are input to a modulator IC 316 via DA converters 314. A response signal that has been converted to an IF-band modulation signal by the modulator IC 316 is further frequency-converted to the RF band by an up-converter 319, and the converted signal is output via a transmitting antenna 322.

<Transmission of response signal at each radio station>

The procedure through which data is broadcast from a transmitting station to a receiving station will now be described.

First, the radio station 101 serving as the transmitting station broadcasts data using OFDM technology. It should be noted that an arrangement may be adopted in which data is broadcast using other technology such as TDMA (Time Division Multiple Access) technology. The radio stations 102 to 106 serving as the receiving stations each receive the signal from the radio station 101 independently. Each of the radio stations 102 to 106 generates and transmits a response signal (Ack) if the data could be decoded normally in the OFDM demodulator 3120 of each of these radio stations.

The radio stations 102 to 106 each transmits the response signal (Ack) at a frequency stored previously in the frequency adjusting unit 3132, by way of example. It should be noted that the frequency that has been assigned to each individual radio station and stored in the frequency adjusting unit 3132 is different from that of the other receiving stations, and the frequency that has been set corresponds to any subcarrier among the subcarriers of the OFDM signal. Further, on the basis of the reception timing of the OFDM signal from the radio station 101, each of the radio stations 102 to 106 transmits the response signal at the same timing.

By adopting such as arrangement, the response from each receiving station with regard to the data that has been broadcast can be made in a very short period of time. An efficient reception response can be achieved and communication efficiency improved especially in broadcast communication in cases where the number of communicating stations is limited, as in the case of a PAN.

<Reception of response signal at each radio station>

In a case where each radio station receives response signals from the other radio stations (receiving stations) using its receiver 3a, the reception levels of the response signals from each of these radio stations received at the antenna 301 are different. Consequently, in a case where response signals from each of the radio stations (receiving stations) are received simultaneously, the proportion of total power occupied by the reception power of each station differs for every radio station.

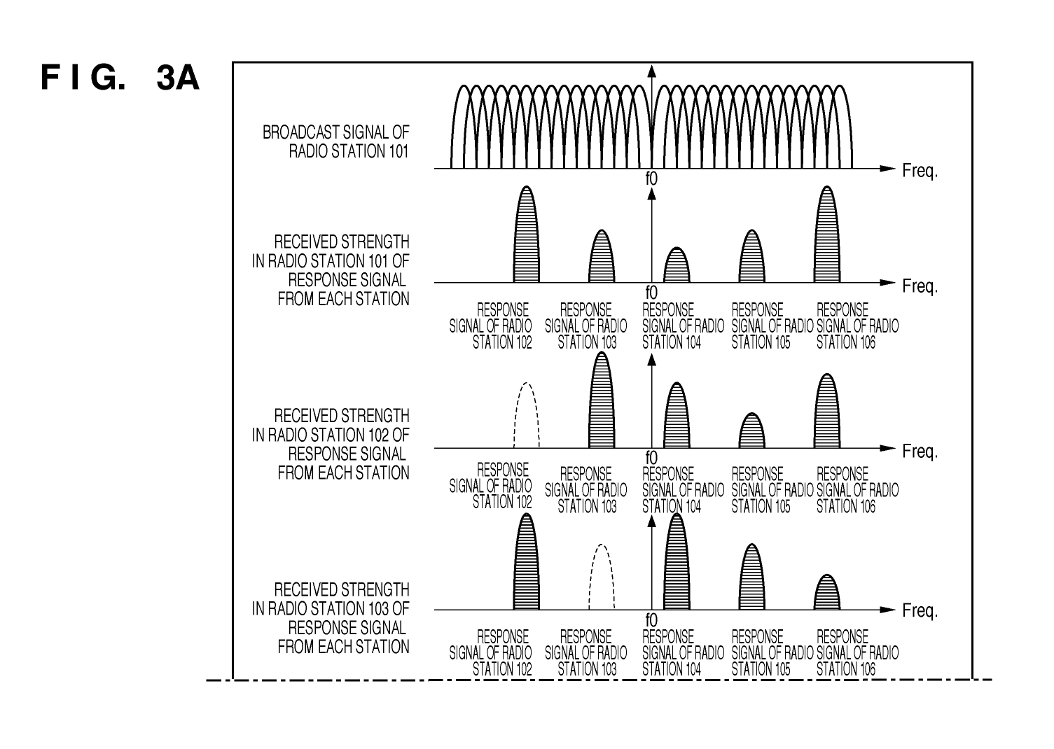

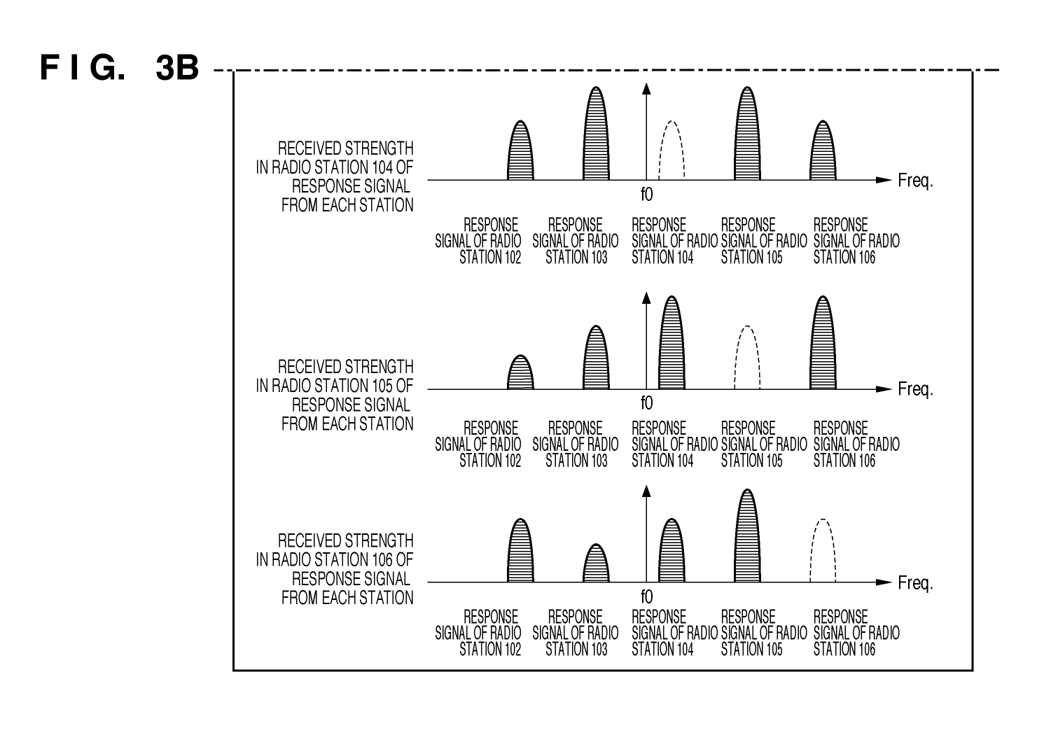

FIGS. 3A and 3B are diagrams schematically illustrating the relationship among the frequencies of the transmitted signal from the radio station 101 and of the response signals at the radio stations 101 to 106. As shown in FIGS. 3A and 3B, frequency is plotted along the horizontal axis and the received strength of the radio waves is plotted along the vertical axis. In a case where the radio stations 102 to 106 that make a reception response transmit their response signals at the same transmission power, the reception levels of the response signals at the radio stations differ depending upon the distances between the radio stations and the state of multipath, as illustrated in FIGS. 3A and 3B.

In FIG. 1, for example, assume that the distance between radio stations 101 and 102 is 1 m and that the distance between radio stations 101 and 104 is 5 m. If the reception level decreases in inverse proportion to the square of distance, then the reception level of the signal received from radio station 102 at radio station 101 will be 25 times the reception level of the signal received from radio station 104.

In this case, the gain controller 3123 of the radio station 101 serving as the transmitting station generally is greatly influenced by the radio stations 102 and 106 for which the reception levels are high and adjusts the reception gain of the variable gain amplifier 307. As a result, the reception level of the response signal from the radio station 104, which signal is received by the receiver (response receiving means) 3a of radio station 101, is extremely low. In the AD converter 311 of the radio station 101 serving as the transmitting station, however, it is required that the response signal of the radio station 104 be demodulated. Accordingly, it is best to adopt an arrangement in which resolution is set in such a manner that the signal of the radio station 104 whose reception level is lowest (minimum) can be discriminated when the gain controller 3123 of the radio station 101 has automatically adjusted gain to make all reception signal levels the maximum value of the AD converter 311.

In accordance with the wireless communication system according to the first embodiment, as described above, a transmitting apparatus serving as a transmitting station broadcasts data using a plurality of subcarriers and receives response signals, which are transmitted from a plurality of receiving stations and indicate the state of data reception, using carriers of frequencies corresponding to any subcarriers of a plurality of mutually orthogonal subcarriers that differ for every receiving station. Further, a communication apparatus serving as a receiving station transmits a response signal, which indicates the state of reception of data that has been broadcast from a transmitting station, using a carrier of a frequency corresponding to any subcarrier of a plurality of mutually orthogonal subcarriers that differ from the subcarriers of the other receiving stations. Accordingly, responses from a plurality of radio stations regarding data that has been broadcast from a transmitting station can be issued in a very short period of time.

A second embodiment of the present invention will be described with regard to a mode in which the transmission levels of response signals are controlled based upon the reception levels of response signals, which were transmitted from each of the radio stations in the past, at other radio stations. It should be noted that the overall configuration of the system is similar to that of the first embodiment and need not be described again.

<Internal configuration of radio stations>

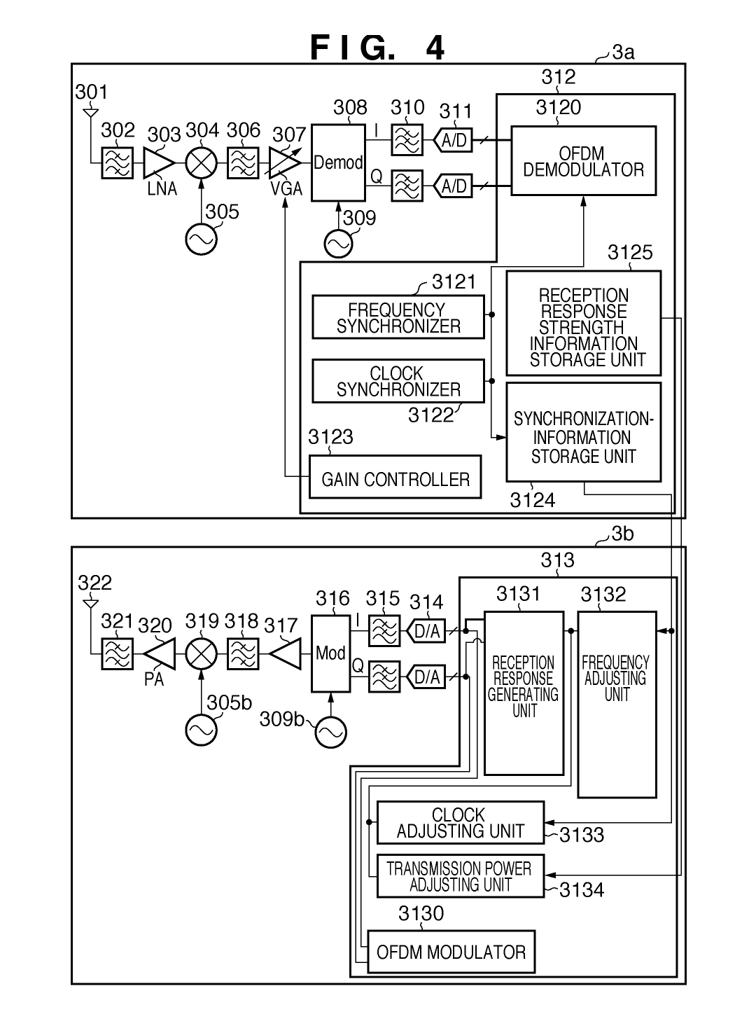

FIG. 4 is a diagram illustrating an example of the configuration of a transmitter and a receiver with which a radio station is equipped in the second embodiment. Elements similar to those of the first embodiment are designated by like reference characters. Specifically, the receiver 3a is additionally provided with a storage unit 3125 for storing information concerning the strength of the reception response. Further, the transmitter 3b is additionally provided with a transmission power adjusting unit 3134 for controlling transmission power.

The strength information storage unit 3125 stores information representing the reception levels, at other radio stations, of a response signal that this particular radio station transmitted in the past. For example, the radio stations 102 to 106 transmit response signals at the same transmission power level, and the radio station 101 stores the reception power levels of the response signals from the radio stations 102 to 106 in the strength information storage unit 3125. Furthermore, the radio station 101 transmits information relating to the reception power level to the radio stations 102 to 106, and each of the radio stations 102 to 106 stores this information in its own strength information storage unit 3125. By adopting such an arrangement, the processing described below will be possible in a case where the reception levels of the response signals from the radio stations 102 to 106, or the amounts of attenuation between radio stations, are known.

For example, assume that the reception levels of response signals, which were transmitted from each of the radio stations in the past, at other radio stations are as illustrated in FIGS. 3A and 3B. In this case, control is exercised in such a manner that the radio station 104, which had the lowest reception level at the radio station 101, performs its transmission at maximum power. On the other hand, the radio stations 102, 103, 105 and 106 each lower their transmission power based upon the information that has been stored in their own strength information storage unit 3125. Preferably, the radio stations 102 to 106 carry out transmission power control (transmission level adjustment) of the response signals in such a manner that the reception levels of the response signals from each of the radio stations will be the same.

By adopting such an arrangement, the differences between the reception levels of the reception signals from each of the radio stations become small in the receiving section of the radio station 101 and demodulation of the reception signals is facilitated. This means that an accurate reception response of each radio station is obtained in a case where the radio station 101 re-sends data.

Similarly, in a case where the radio station 102, for example, is a repeater station, each radio station will adjust the transmission level of the reception response in such a manner that the reception responses of each of the radio stations at the radio station 102 will become the same level. In this way an accurate response of each radio station is obtained even in a case where the radio station 102 relays the response signals.

An arrangement may be adopted in which the effects of multipath fading or the like are estimated based upon the information that has been stored in the strength information storage unit 3125. For example, it is convenient to adopt an arrangement in which, when reception quality has deteriorated despite the fact that the reception level is sufficiently high, it is assumed that multipath fading exists and the frequencies at which the response signals are transmitted are interchanged among the radio stations. In other words, by adjusting reception quality at each radio station, it is possible to select a combination that will not be readily susceptible to the effects of multipath fading.

In accordance with the wireless communication system according to the second embodiment, as described above, an effect obtained is that it is possible for a transmitting station to demodulate response signals from receiving stations more easily.

A third embodiment of the present invention will be described with regard to a mode in which it is possible to facilitate the demodulation of response signals from receiving stations by changing the configuration of the receiving section of the transmitting station. It should be noted that the overall configuration of the system is similar to that of the first embodiment and need not be described again.

<Configuration of receiving section of radio stations>

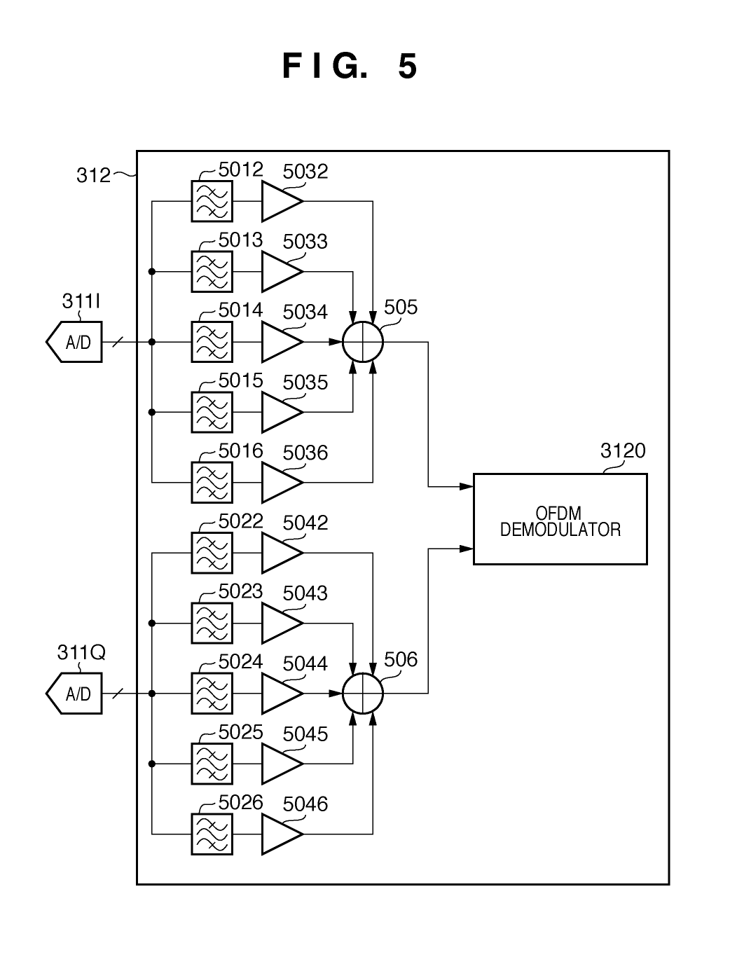

FIG. 5 is a diagram illustrating the internal configuration of the demodulator 312 of the digital IC. Narrow-band band-pass filters 5012 to 5016 for the reception responses of the radio stations 102 to 106 and a combiner 505 are inserted between the OFDM demodulator 3120 and AD converter 3111 for the I-component signal. Similarly, narrow-band band-pass filters 5022 to 5026 for the reception responses of the radio stations 102 to 106 and a combiner 506 are inserted between the OFDM demodulator 3120 and AD converter 311Q for the Q-component signal.

Further, reception-response gain adjusters 5032 to 5036 and 5042 to 5046 for the radio stations are inserted between the narrow-band band-pass filters 5012 to 5016 and combiner 505 and between the narrow-band band-pass filters 5022 to 5026 and combiner 506, respectively. These narrow-band band-pass filters, combiners and gain adjusters are used only when reception responses are received from each of the radio stations.

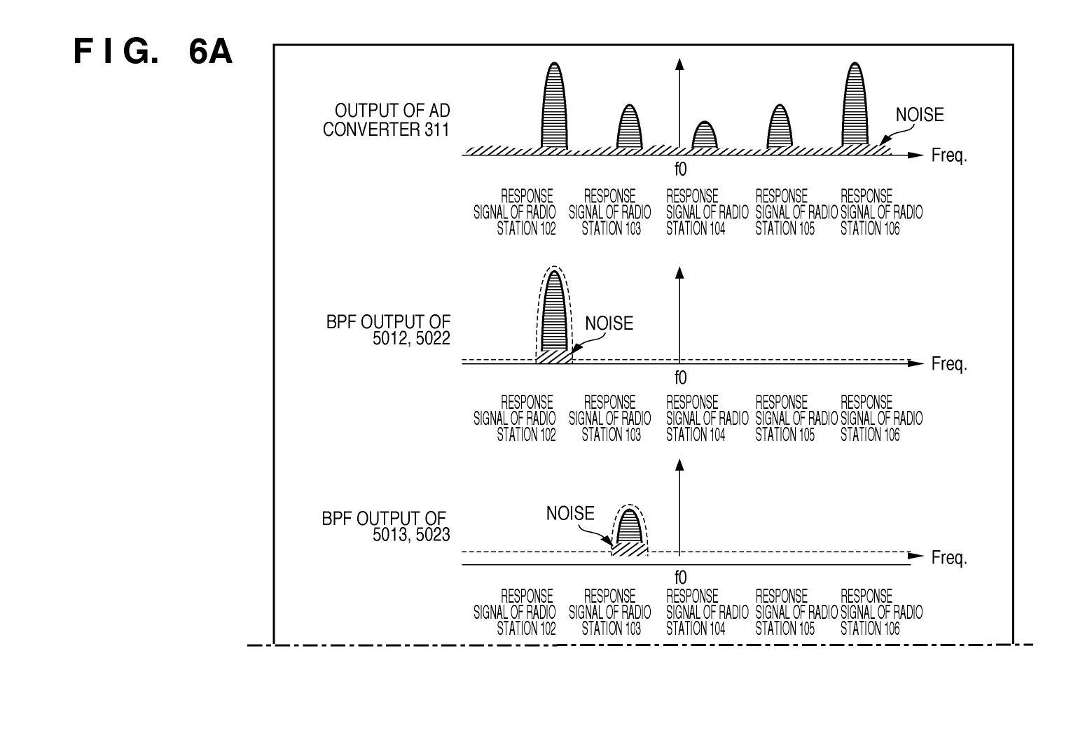

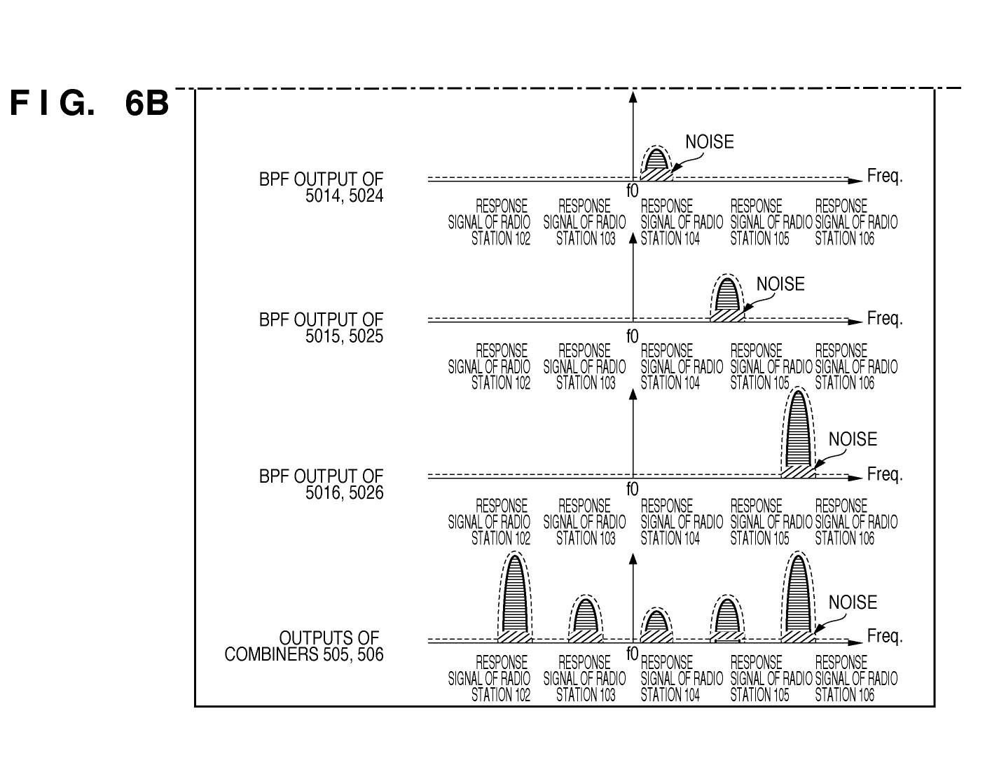

FIGS. 6A and 6B are diagrams exemplifying outputs from the combiners when the demodulator 312 shown in FIG. 5 is used. As illustrated in FIGS. 6A and 6B, it is possible to eliminate out-band noise in the response signal from each radio station (receiving station) by using each narrow-band band-pass filter and combiner. The result is a relative improvement in reception sensitivity.

In accordance with the wireless communication system according to the third embodiment, as described above, an effect obtained is that it is possible for a transmitting station to demodulate response signals from receiving stations more easily.

A fourth embodiment of the present invention will be described with regard to a mode in which it is possible to facilitate the demodulation of response signals from receiving stations, with a reduced amount of computation, by changing the configuration of the receiving section of the transmitting station. It should be noted that the overall configuration of the system is similar to that of the first embodiment and need not be described again.

<Configuration of receiving section of radio stations>

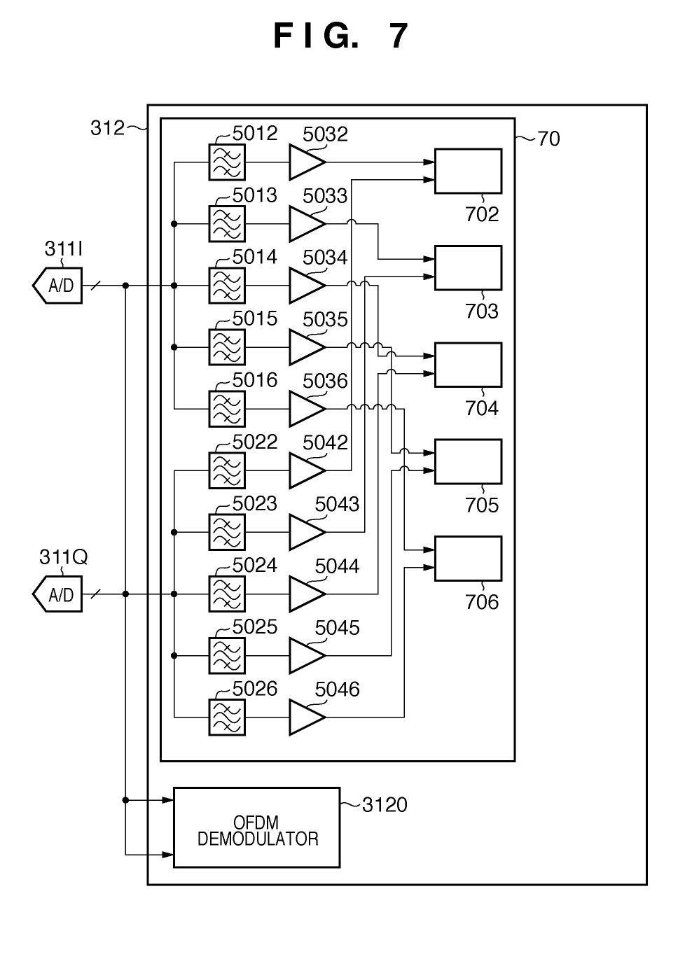

FIG. 7 is a diagram illustrating the internal configuration of the demodulator 312 of the digital IC. Here the arrangement is one in which the OFDM demodulator 3120 and a reception response demodulator 70 are separate from each other. Furthermore, the reception response demodulator 70 includes demodulating units 702 to 706 corresponding to the radio stations 102 to 106, respectively, so that the response signals from the respective radio stations are demodulated individually.

In terms of receiver structure, there are cases where, depending upon the number of significant digits in the demodulating operation, the overall amount of computation is reduced more by operating individually on a plurality of signals of different sizes. In the fourth embodiment, therefore, amount of computation is reduced by computing the reception response from each radio station individually.

Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-063235, filed Mar. 16, 2009, which is hereby incorporated by reference herein in its entirety.

1. A communication apparatus comprising:
a receiving unit that receives data that has been broadcast from a transmitting apparatus to a plurality of communication apparatuses; and
a transmitting unit that transmits a response signal regarding the data received by the receiving unit, using a carrier different from carriers of the other communication apparatuses from among a plurality of mutually orthogonal carriers.

2. The apparatus according to claim 1, wherein the transmitting unit transmits a response signal using a carrier having a frequency different from frequencies of the other communication apparatuses.

3. The apparatus according to claim 1, further comprising storage unit for storing a pre-assigned frequency;
wherein the transmitting unit transmits the response signal using a carrier having the frequency stored by the storage unit.

4. The apparatus according to claim 1, wherein the transmitting unit transmits a response signal regarding the data based upon timing at which the data is received by the receiving unit.

5. The apparatus according to claim 1, further comprising an adjusting unit that adjusts modulation of the response signal based upon demodulation information prevailing when the data received by the receiving unit is demodulated.

6. The apparatus according to claim 5, wherein the demodulation information includes at least one of frequency synchronization information and clock synchronization information.

7. The apparatus according to claim 1, further comprising a power adjusting unit that adjusts transmission power level of the response signal, which is transmitted by the transmitting unit, in such a manner that reception power levels of the response signals from the plurality of communication apparatuses will take on a predetermined value at the transmitting apparatus.

8. The apparatus according to claim 1, wherein the transmitting unit transmits the response signal using a carrier having a frequency assigned based upon reception qualities of the response signals from the plurality of communication apparatuses.

9. The apparatus according to claim 1, wherein the transmitting unit transmits the response signal at a timing identical with that of the plurality of communication apparatuses.

10. A communication apparatus comprising:
a transmitting unit that broadcasts data to a plurality of communication parties; and
a receiving unit that receives response signals, which indicate states of reception of the data, from the plurality of communication parties;
wherein the receiving unit receives the response signals transmitted using carriers, which are different for every communication party, from among a plurality of mutually orthogonal carriers.

11. The apparatus according to claim 10, wherein the receiving unit receives the response signals using carriers having frequencies corresponding to any of the plurality of carriers.

12. The apparatus according to claim 10, further comprising an adjusting unit that adjusts reception gain in the receiving unit so as to make it possible to demodulate a reception signal having the minimum reception power level among the reception signals from each of the plurality of communication parties.

13. The apparatus according to claim 10, wherein the receiving unit has a plurality of receiving sections that include a narrow-band filter for extracting the response signal from each of the plurality of communication parties.

14. A method of controlling a communication apparatus, comprising:
a receiving step of receiving data that has been broadcast from a transmitting apparatus to a plurality of communication apparatuses; and
a transmitting step of transmitting a response signal regarding the data using a carrier different from carriers of the other communication apparatuses from among a plurality of mutually orthogonal carriers.

15. A method of controlling a communication apparatus, comprising:
a broadcasting step of broadcasting data to a plurality of communication parties using a plurality of carriers; and
a receiving step of receiving response signals, which indicate states of reception of the data, from the plurality of communication parties;
wherein the response signals transmitted using carriers, which are different for every communication party, from among a plurality of mutually orthogonal carriers are received at the receiving step.

16. A non-transitory computer-readable storage medium storing a computer program for causing a computer to execute the control method set forth in claim 14.

17. A communication system comprising a transmitting apparatus and a receiving apparatus, wherein the transmitting apparatus includes a first transmitting unit that broadcasts data to a plurality of receiving apparatuses; and
the receiving apparatus includes:
a receiving unit that receives the data transmitted by the first transmitting unit; and
a second transmitting unit that transmits a response signal regarding the data received by the receiving unit, using a carrier different from carriers of the other communication apparatuses from among a plurality of mutually orthogonal carriers.
